(19) United States
(12) Patent Application Publication
(10) Pub. No.: US 2008/0320557 A1
(43) Pub. Date: Dec. 25, 2008

(54) BATCH VERIFICATION DEVICE, PROGRAM AND BATCH VERIFICATION METHOD

(76) Inventors: Keisuke Hakuta, Kawasaki (JP); Hisayoshi Sato, London (GB)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/046,585

(22) Filed: Mar. 12, 2008

(30) Foreign Application Priority Data
Jun. 25, 2007 (JP) 2007-165892

(51) Int. Cl. G06F 21/00

(52) U.S. Cl. 726/2

(57) ABSTRACT

Realization of batch verification having both high security and high efficiency.

A mathematical function computing part (136) is provided that replaces an order of a multiple batch instances, specifies a number corresponding to the replaced order, and carries out verification based on whether or not a value calculated by carrying out a modular exponentiation of a generator of a finite cyclic group, with a multiplied value, obtained by multiplying a first value of a batch instance by a number corresponding to the order, as an exponent, and a value calculated by carrying out a modular exponentiation of a second value of the batch instance, with a number corresponding to the order as an exponent, are in agreement

This application claims priority based on the Japanese Patent Application No. 2007-165892 filed on Jun. 25, 2007, the entire content of which is hereby incorporated by reference.

### BACKGROUND OF THE INVENTION

The present invention relates to technology for batching and verifying of multiple digital signatures.

By having signers generate signature data for digital signatures using a signature generation key in which the signers are kept secret with respect to the electronic data to be signed, and having signature verifiers decode the signature data using signature verification keys that are open to the public and comparing with the electronic data that is signed, it is possible to detect the presence or absence of any alterations with respect to the authenticity of the signers or the electronic data.

For this type of signature, it is necessary to carry out repetitive and complicated processing when verifying, but in technology described in, for example, M. Bellare, J. Garay and T. Rabin, “Fast Batch Verification for Modular Exponentiation and Digital Signatures”, Advances in Cryptology—EUORCRYPT 1998, LNCS 1403, pp. 236-250, 1998, (referred to as Reference 1), batch verifying of multiple digital signatures enables improvement in the efficiency of verification processing of the digital signatures.

The batch verification method described in Reference 1 is explained below.

Furthermore, below, G is a finite cyclic group of order q (q is a large prime number) and g is a generator of the group G. Also, (xᵢ, yᵢ) (i is an index indicating order and is a natural number satisfying 1≦i≦n) is a set (batch instance) to verify whether or not Equation (1) below is satisfied.

g^{xi}=yᵢ (1)

Here, for each i (i=1, . . . , n) xᵢ, yᵢ satisfy Equations (2) and (3) below.

0≦xᵢ≦q−1 (2)

yᵢ ∈ G (3)

A batch instance (xᵢ, yᵢ), (i=1, . . . , n), is “valid” when it satisfies Equation (1) with respect to each i (i=1, . . . , n), and “invalid” when it does not. Furthermore, when the batch instance is valid, the signature data is also deemed to be “valid” and when the batch instance is invalid, the signature data is also deemed to be “invalid”.

Additionally in batch verification, valid batch instances are always accepted as “valid” but there are instances when an invalid batch instance with an extremely small probability is also accepted as “valid”. When the upper limit of the probability that an invalid batch instance will be accepted as “valid” is a maximum of ½^{m} (m is a positive integer), m is called the security level of batch verification. It is well known that with the capability of recent computers it is preferable to have m set to approximately 80. Furthermore, it is well known that the larger the security level m, the higher the security of the digital signatures.

Here, whether or not Equations (4) and (5) below are satisfied is verified with the Random Subset Test described in Reference 1 while in normal signature verification, whether or not Equation (1) is satisfied with respect to the digital signature corresponding to each i (i=1, . . . , n) is verified for each separate instance.

g^{Σs}^{ᵢ}^{x}^{ᵢ}=Π yᵢ^{s}^{ᵢ} (4)

sᵢ=0 [symbol] 1(i=1, . . . , n) (5)

Here, as shown in Equation (5), 0 or 1 are randomly selected for sᵢ with respect to each i (i=1, . . . , n).

Furthermore, the Small Exponents Test described in Reference 1 verifies whether Equations (6) and (7) below are satisfied.

g^{Σs}^{ᵢ}^{x}^{ᵢ}=Π yᵢ^{s}^{ᵢ} (6)

0≦sᵢ≦2^{m}−1)(i=1, . . . , n) (7)

Here, Sᵢ (i=1, . . . , n) is a randomly selected integer from [0, . . . , 2^{m}−1]. Here, m is an arbitrary positive integer and the security level is determined from this m.

Additionally, as shown in Equation (5), “Random” in the Random Subset Test stems from randomly selecting si for each i (I=1, 2, 3, . . , n). The Random Subset Test accepts an “invalid” batch instance as “valid” with a probability of ½ at most. Consequently, in order to actually set the security level at m, the Atomic Random Subset Test is used to perform the Random Subset Test m times independently. By doing this, the probability that the Atomic Random Subset Test, which carries out the Random Subset Text m times independently, will accept an “invalid” batch instance as “valid” is ½^{m} at most. Furthermore, even in the Small Exponents Test mentioned above, the probability of an “invalid” batch instance being accepted as “valid” is a ½^{m} at most.

On this point, the efficiency of the batch verification described in Reference 1 depends on the number n of batch instances and the security level m.

### SUMMARY OF THE INVENTION

The efficiency of the batch verification described in Reference 1 depends on the number n of batch instances and the security level m but there is a trade-off relationship between efficiency and security (security level m) in that if high security is desired, high efficiency cannot be expected.

This invention achieves batch verification combining both high security and high efficiency.

In order to resolve the above problem, this invention specifies an order in multiple signature data and produces a number in accordance with the specified order.

For instance, this invention is a batch verification device that collectively verifies batch instances of multiple signature data; wherein the order in the multiple signature data is specified; the batch instances comprise a first value and a second value; and the batch verification part comprises a processing part for verification based on whether or not a value calculated by carrying out an exponentiation of a generator of a finite multiplicative cyclic group, with a multiplied value obtained by multiplying the first value by a number which differs depending on the order, as an exponent; and a value calculated by carrying out an exponentiation of the second value, with a number which differs depending on the order as an exponent, are in agreement.

As shown above, according to this invention, it is possible to achieve batch verification combining high security and high efficiency.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a diagram exemplifying an outline of a signature batch verification system for a first embodiment;

FIG. 2 is a diagram exemplifying an outline of a signature device;

FIG. 3 is a diagram exemplifying an outline of a verification device;

FIG. 4 is a diagram exemplifying an outline of a mathematical function computing part;

FIG. 5 is a diagram exemplifying an outline of a hardware structure of a computer;

FIG. 6 is a sequence diagram exemplifying signature generation processing in the signature device;

FIG. 7 is a sequence diagram exemplifying signature batch verification processing in the verification device;

FIG. 8 is a flow chart exemplifying the batch verification processing in the mathematical function computing part;

FIG. 9 is a flow chart exemplifying replacement processing in a permutation part;

FIG. 10 is a diagram comparing computing costs (processing time);

FIG. 11 is a diagram exemplifying an outline of the signature device;

FIG. 12 is a diagram exemplifying an outline of the verification device;

FIG. 13 is a flow chart exemplifying the batch verification processing in the mathematical function computing part;

FIG. 14 is a diagram exemplifying an outline of the signature device;

FIG. 15 is a diagram exemplifying an outline of the verification device;

FIG. 16 is a flow chart exemplifying the batch verification processing in the mathematical function computing part; and

FIG. 17 is a diagram exemplifying an outline of network surveillance camera system.

### DETAILED DESCRIPTION OF THE INVENTION

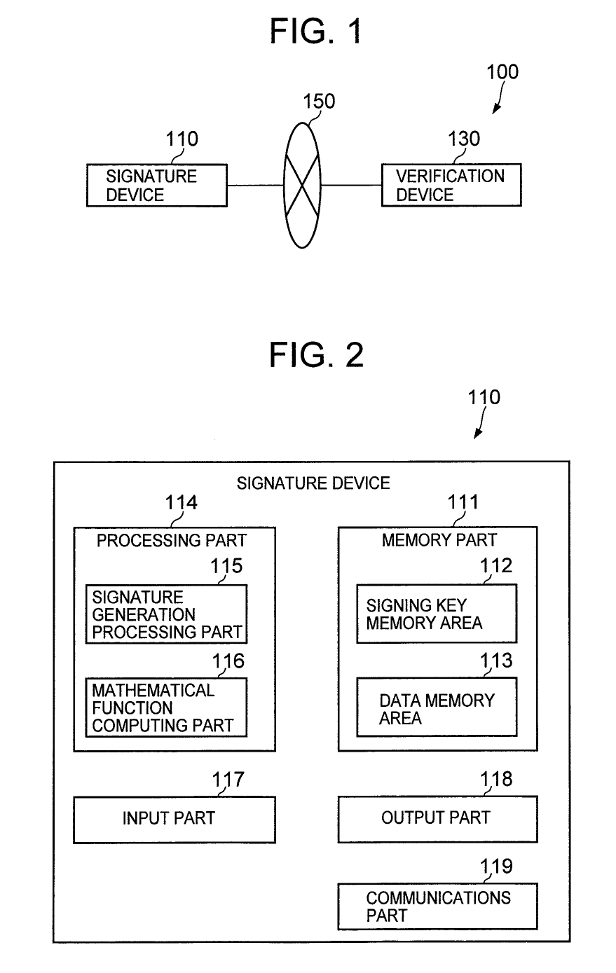

FIG. 1 is an outline of a signature batch verification system 100 which is a first embodiment of this invention.

As shown in the diagram, the signature batch verification system 100 includes a signature device 110 and a verification device 130 and it is possible with this signature device 110 and verification device 130 to mutually send and receive information through a network 150. In this embodiment of the signature batch verification system 100, signatures are generated with respect to messages M in the signature device 110 and batch verification of the signatures is carried out in the verification device 130.

FIG. 2 is an outline of the signature device 110.

As shown in the diagram, the signature device 110 is composed of a memory part 111, a processing part 114, an input part 117, an output part 118 and a communications part 119.

A signing key memory area 112 and a data memory area 113 are set up in the memory part 111.

A signing key, which is the key information when executing the signature, is stored in the signing key memory area 112.

A message which is data to be electronically signed is stored in a data storage area 113.

The processing part 114 is composed of a signature generation processing part 115 and a mathematical function computing part 116.

The signature generation processing part 115 controls processing in which the signature data is generated with respect to the message to be electronically signed.

For instance, in this embodiment, the signature generation processing par 115 generates the input data by inputting the message to be electronically signed into a predetermined hash function.

The signature generation processing par 115 obtains the signing key stored in the signing key memory area 112 and inputs it into the mathematical function computing part 116 along with the input data.

The signature generation processing par 115 obtains the signature generated from the mathematical function computing part 116 and transmits it with the signature and the message as the signature data to the verification device 130 through the communications part 139.

The mathematical function computing part 116 with respect to the input data input from the signature generation processing par 115 generates a signature using the signing key input from the signature generation processing par 115 and encodes it by means of a predetermined algorithm.

The mathematical function computing part 116 outputs the signature generated in this manner to the signature generation processing par 115.

The input part 117 receives the input information.

The output part 118 outputs the information.

The communications part 119 carries out the transmitting and receiving of the information through the network 150.

The signature device 110 described above can be achieved with, as shown in FIG. 5 (outline of computer 160), a general computer 160 comprising a CPU 161, memory 162, an external memory device 163 such as an HDD, a reading device 165 which reads the information from a storage medium 164 which is portable, such as a CD-ROM or a DVD-ROM, an input device 166 such as a keyboard or mouse, an output device 167 such as a display, and a communications device 168 such as an NIC (Network Interface Card) for connecting to a communications network.

For example, the memory part 111 is realizable by having the CPU 161 use the memory 162 or external storage device 163; the processing part 114 is realizable by having a predetermined program stored in the external memory device 163 loaded in the memory 162 and executed by the CPU 161; the input part 117 is realizable by having the CPU 161 use the input device 166, the output part 118 is realizable by having the CPU 161 use the output device 167, and the communications part 119 is realizable by having the CPU 161 use the communications device 168.

This predetermined program may be downloaded to the external storage device 163 from the storage medium 164 through the reading device 165 or from the network through the communications device 168 and then loaded in the memory 162 and executed by the CPU 161. Additionally, it may be directly loaded to the memory 162 from the storage medium 164 through the reading device 165 or from the network through the communications device 168 and executed by the CPU 161.

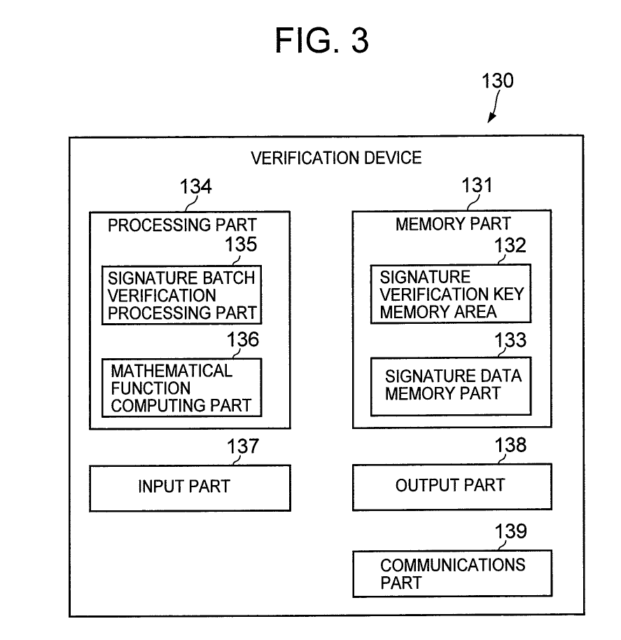

FIG. 3 is an outline of the verification device 130.

The verification device 130 is composed of the memory part 131, the processing part 134, the input part 137, the output part 138, and the communications part 139.

The signature verification key memory area 132 and the signature data memory area 133 are set up in the memory part 131.

The signature verification key, which is the key information for encoding and verifying the signature contained in the signature data transmitted from the signature device 110, is stored in the signature verification key memory area 132.

The signature data transmitted from the signature device 110 is stored in the signature data storage area 133.

The processing part 134 is composed of the signature batch verification processing part 135 and the mathematical function computing part 136.

The signature batch verification processing part 135 controls the processing that batches and verifies the signature data transmitted from the signature device 110.

For example, in this embodiment, the signature batch verification processing part 135 receives the signature verification key pk stored in the signature verification key memory area 132 and the signature data stored in the signature data storage area 133 from the storage part 131 and inputs them into the mathematical function computing part 136.

The signature batch verification processing part 135 receives the results of the batch verification from the mathematical function computing part 136 and either stores it to the storage area 131 or outputs the verification results through the output part 138 or the communications part 139.

The mathematical function computing part 136, with respect to the signatures contained in the signature data input from the signature batch verification part 136, uses the signature verification key input from the signature batch verification part 135, carries out batch processing of the signatures by means of a predetermined algorithm, and confirms the validity of the signatures.

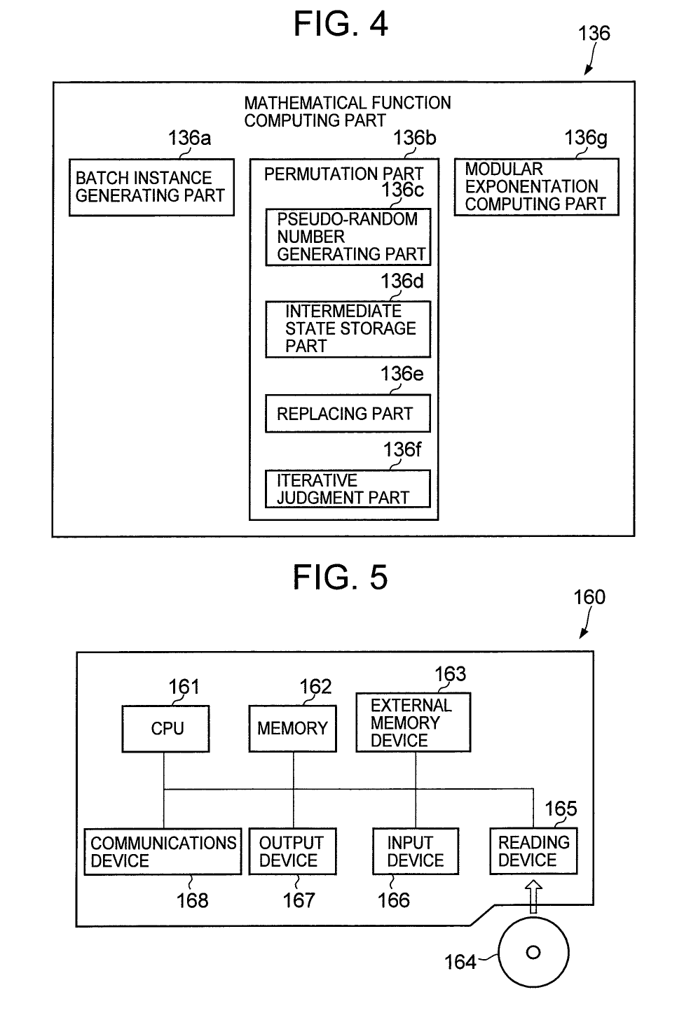

For example, in this embodiment, the mathematical function computing part 136 as shown in FIG. 4 (outline of the mathematical function computing part 136) is composed of a batch instance generating part 136a, a substitute part 136b and a modular exponentiation computing part 136f.

The batch instance generating part 136a generates a batch instance from the signature contained in the signature data input from the signature batch verification part 135. Here, the batch instance generating method depends on the form of the signature used in the signature device 110 and the verification device 130. Furthermore, when the signature generated by the form of the signature used in the signature device 110 and the verification device 130 becomes the batch instance, it is not necessary to set up the batch instance generating part 136a in the mathematical function computing part 136. Additionally, an explanation will be given in Embodiments 2 and 3 described later regarding the specific generating method of the batch instances.

The permutation part 136b carries out processing to change the order of the batch instances.

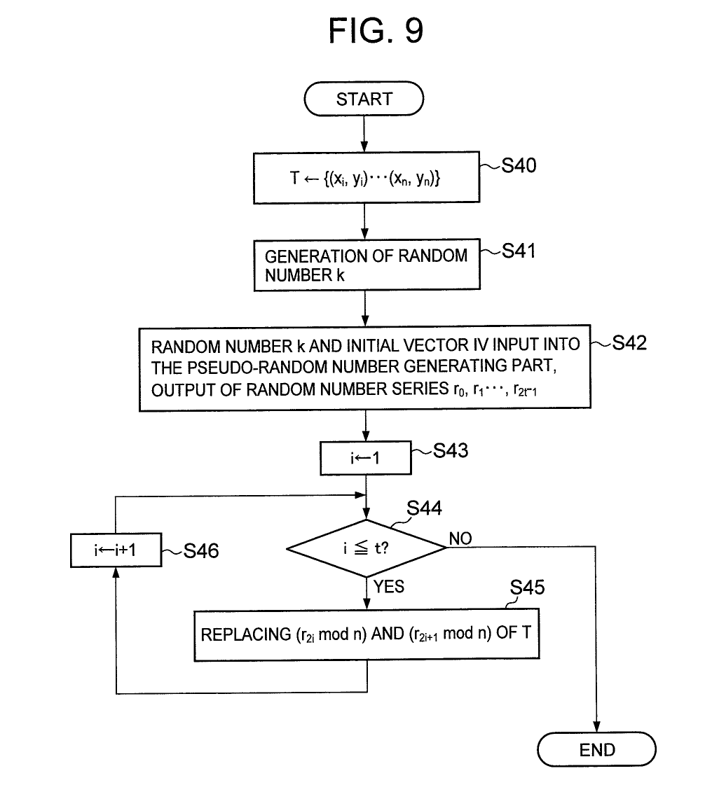

An arbitrary change method may be used for changing the order of the batch instances, but in this embodiment the change is effected using a pseudo-random number generating part 136c, an intermediate state storage part 136d, a replacing part 136e, and an iterative judgment part 136f. Furthermore, a detailed explanation regarding the specific change method will be given using FIG. 9.

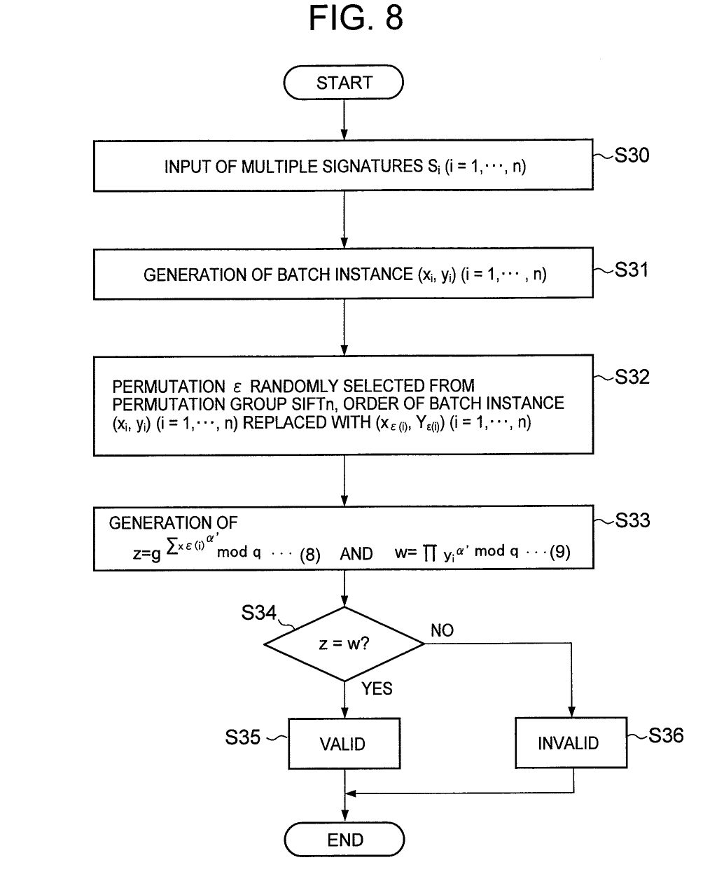

The modular exponentiation computing part 136f carries out verification by performing modular exponentiation on the batch instances which have been replaced by the permutation part 136b. Additionally, a detailed explanation will be given using FIG. 8 regarding processing with the modular exponentiation computing part 136f.

The input part 137 receives the input of the information.

The output part 138 outputs the information.

The communications part 139 transmits and receives the information through the network 150.

The above described verification device 130 may also be used with a general computer 160 as, for example, shown in FIG. 5 (outline of the computer 160).

For example, the memory part 131 is realizable by having the CPU 161 use the memory 162 or external storage device 163; the processing part 134 is realizable by having a predetermined program stored in the external memory device 163 loaded in the memory 162 and executed by the CPU 161; the input part 137 is realizable by having the CPU 161 use the input device 166; the output part 138 is realizable by having the CPU 161 use the output device 167, and the communications part 139 is realizable by having the CPU 161 use the communications device 168.

This predetermined program may be downloaded to the external storage device 163 from the storage medium 164 through the reading device 165 or from the network through the communications device 168, and then loaded in the memory 162 and executed by the CPU 161. Additionally, it may be directly loaded to the memory 162 from the storage medium 164 through the reading device 165 or from the network through the communications device 168 and executed by the CPU 161.

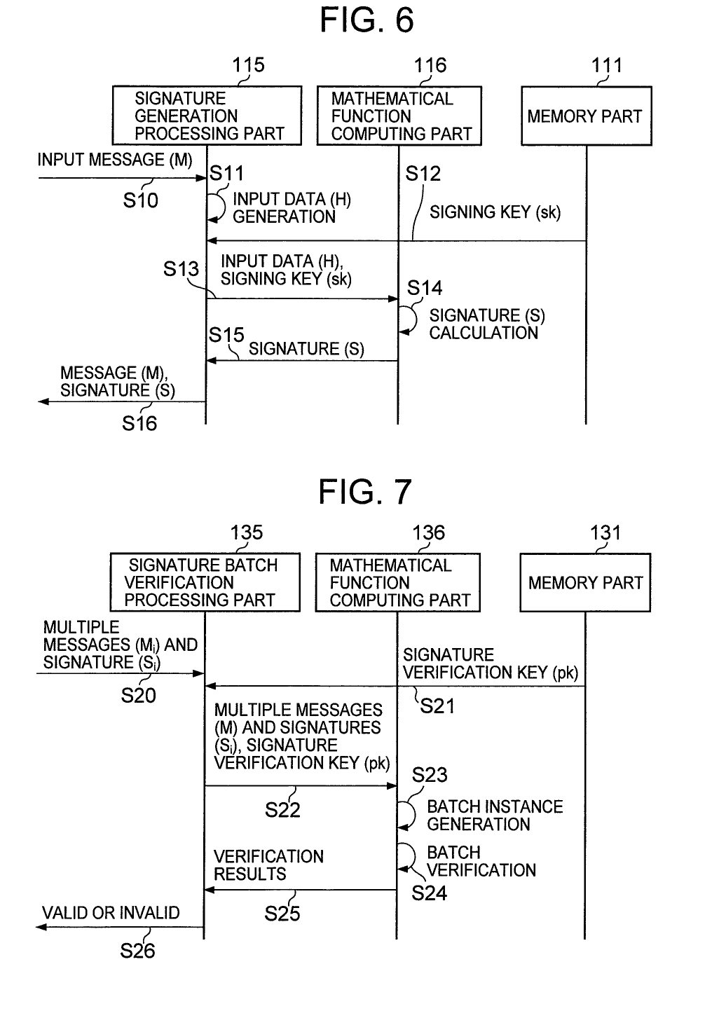

FIG. 6 is a sequence diagram for exemplifying the signature generating processing in the signature device 110.

First, the signature generation processing par 115 in the signature device 110 obtains the message M input through the input part 117 or stored in the data memory area 113 (S10). Here, the message M may be digitalized data and it does not matter what type the text, graphics or images or sound is.

Next, the signature generation processing par 115 generates the input data H from the received message M (S11). The input data H, for example, in the hash value of the message M, depends on the message M or the type of signature used.

Next, the signature generation processing par 115 reads the signing key sk that is stored in the signing key memory area 112 in the memory area 111 (S12).

The signature generation processing par 115 inputs the read signing key sk and the input data H generated in S11 into the mathematical function computing part 116 (S13).

The mathematical function computing part 116 computes the signature S from the input signing key sk and the input data H (S14). Here, the signature S is a computed value that depends on the signature method adopted.

The mathematical function computing part 116 outputs the computed signature S to the signature generation processing par 115 (S15).

The signature generation processing par 115 transmits as the signature data the received signature S and the message M to the verification device 130 through the communications part 119 (S16).

Furthermore, the reception timing of the signing key sk from the memory part 111 in step S12 may be before the signing key sk is output to the mathematical function computing part 116 and may, for example, be before the message M is received (S10).

FIG. 7 is a sequence diagram exemplifying the batch verification processing of signatures in the verification device 130.

First, the signature batch verification processing part 135 in the verification device 130 receives an arbitrary amount of signature data input through the input part 137 or the communications part 139 or stored in the signature data memory area 133 in the memory part 131 (S20).

Also, the signature batch verification processing part 135 reads the signature verification key pk stored in the signature verification key memory area 132 in the memory part 131 (S21).

The signature batch verification processing part 135 inputs the received multiple signature data and the read signature verification key pk into the mathematical function computing part 136 (S22).

The batch instance is generated by the mathematical function computing part 136 from the signature S contained in the input multiple signature data (S23). Additionally, when the signature S is already a batch instance, it is not necessary to generate a batch instance.

The mathematical function computing part 136 carries out predetermined batch verification from the input signature verification key pk and the batch instances (S24), and outputs the results as verification results to the signature batch verification processing part 135 (S25). Furthermore, a detailed description using FIG. 8 to be described later will be given regarding batch verification processing of the signatures with the mathematical function computing part 136.

The signature batch verification processing part 135 which has received these verification results either stores them in the storage part 131 or outputs the verification results (whether the signature data is valid or invalid) through the output part 138 or the communications part 139 (S26).

Furthermore, reading the signature verification key pk from the memory part 131 may be done before carrying out the batch verification in the mathematical function computing part 136 and, for example, may be before the signature data is received in step S20.

FIG. 8 is a flow chart exemplifying the batch verification processing in the mathematical function computing part 136.

Here, in this embodiment, regarding the batch verification of the signatures, G is a finite cyclic group of order q (q is a large prime number), g is a generator of the group G, and the signature verification key pk is (G, g, q). A specific explanation is given below about the batch verification method for multiple signatures Si (i=1, . . . , n) (n is an arbitrary positive integer).

Batch verification processing in the mathematical function computing part 136 is begun by receiving the input of a random quantity of signature data from the signature batch verification processing part 135 (S30).

When the input of an arbitrary amount of signature data is received from the signature batch verification processing part 135, the batch instance generating part 136a of the mathematical function computing part 136 generates a batch instance (xᵢ, yᵢ) (i=1, . . . , n) from the multiple signatures Si (i=1, . . . , n) contained in the input signature data (S31). Here, the batch instance permutation method depends on the type of signature used. Furthermore, the specific batch instance permutation method will be explained in the second and third embodiments to be described later. Additionally, as explained in Embodiments 2 and 3, signature types in which substitution into the batch instance is unnecessary include, for example, RSA-FDH signature, DSA* signature and ECDSA* signature in Reference 1 and signature types requiring substitution into the batch instance include, for example, DSA* signature and ECDSA* signature in Reference 1.

Additionally, the ECDSA* signature and the ECDSA signature scheme are described in A. Antipa, D. Brown, R. Gallant, R. Lambert, R. Struik, and S. Vanstone, “Accelerated Verification of ECDSA Signatures”, Selected Areas in Cryptography—SAC 2005, LNCS 3897, pp. 307-318, 2006 (referred to below as Reference 2).

The permutation part 136b in the mathematical function computing part 136 randomly selects a permutation ε from a permutation group SIFTₙ, that is, by an arbitrary permutation method the order of the batch instance (Xᵢ, Yᵢ) (i=1, . . . , n) is replaced with (X_{ε(i)}, Y_{ε(i)}) (i=1, . . . , n) (S32). Here, the permutation group SIFTₙ is the total permutation set from the set {1, 2, . . . , n} to the set {1, 2, . . . , n} and it is preferable for the permutation to be bijective. Additionally, a specific example of permutation will be explained in detail using FIG. 9 to be described later.

Next, the modular exponentiation computing part 136f in the mathematical function computing part 136 computes Equations (8) and (9) below, using the substituted (x_{ε(i)}, y_{ε(i)}) (i=1, . . . , n) (S33)

z=gΣ^{x}^{_{ε(i)}}^{α}_{ⁱ} mod 1 (8)

w=Π yᵢ^{α}_{ⁱ} mod q (9)

Here, α in Equations (8) and (9) is an arbitrary natural number and for at least one verification is determined beforehand so as to be the same number in Equations (8) and (9). Furthermore, regarding αⁱ in Equations (8) and (9), there is no limitation to this type of state and a number that differs according to the order i is possible: for example, an arbitrary function f (i) with i as the variable.

The modular exponentiation computing part 136f determines whether or not z computed in Equation (8) and w computed in Equation (9) satisfy Equation (10) below and if they do (Yes in step S34), the signature is deemed to be valid (S35), and if not (No in step S34), the signature is considered to be invalid (S36).

z=w (10)

Furthermore, in this embodiment, verification processing is carried out with z=w, but if verification processing can be carried out, any verification formula may be used and it does not matter what the type of verification formula is.

FIG. 9 is a flow chart exemplifying the permutation processing in the permutation part 136b.

First, the intermediate state storage part 136d in the permutation part 136b stores the batch instance (xᵢ, yᵢ) (i=1, . . . , n) in the area T (S40).

Next, the pseudo-random number generating part 136c in the permutation part 136b generates a random number k. Here, the pseudo-random number generating part 136c inputs the random number k and a predetermined initial vector IV into the pseudo-random number generator and outputs the random number series r₀, r₁, . . . , r₂ₜ₋₁ with respect to a predetermined integer t (S42). Here, the integer t expresses the number of times the batch instance is replaced and is determined beforehand.

The iterative judgment part 136f initializes i (stores 1 in i) (S43).

Next, the iterative judgment part 136f determines whether or not i≦t (S44). When i≦t (Yes in step S44), the process proceeds to step S45 and when not i≦t (No in step S44), the processing is completed.

In step S45, the replacing part 136e replaces the (r₂ᵢ mod n) of the batch instance stored in the area T with (r₂ᵢ₊₁ mod n) (S45).

Additionally, a detailed description of the pseudo-random number generator is given in, for example, D. Watanabe, S. Furuya, H. Yoshida, K. Takaragi, and B. Preneel, “A New Keystream Generator MUGI”, IEICE Transactions on Fundamentals of Electronics, Communications and Computer Sciences, vol. E87-A, No.1, 2004.

Processing is repeated in which i is incremented (i←i+1) (S46) and a return is made to step (S44).

Furthermore, the value of the integer t may be a predetermined fixed value or may change for each batch verification.

Additionally, the substitution preparation method is not limited to this mode, and, for example, once a table (a table corresponding to the order prior to the permutation and the order after the permutation) is prepared and stored beforehand indicating the permutations, and the permutations are carried out based on this table, the method is not limited.

Additionally, the permutation method may be changed each time for the batch verification and may be changed after being used a multiple times. However, when a specific permutation method is used a multiple times, from the standpoint of security it is necessary that the permutation method not be known to the signature verifiers.

Furthermore, in the batch instance (xᵢ, yᵢ) (i=1, . . . , n), if Equation (1) above is satisfied with respect to each i (i=1, . . . , n), Equation (10) above is satisfied. That is, the signature batch verification method always receives a valid batch instance as “valid”. The reason is given below.

If Equation (1) is satisfied with respect to each i (i=1, . . . , n), Equation (11) below will hold.

g^{x}^{_{ε(i)}} mod q=y_{ε(i)} mod q (11)

Equation (12) below is formed from Equation (11).

g^{x}^{_{ε(i)}}^{α}^{^{t}} mod q=y_{ε(i)}^{α}^{^{t}} mod q (12)

The upper limit of the probability that the above described signature batch verification method will receive an invalid batch instance as “valid” is a maximum 1/q. The reason for this is given below.

When the integer j (i) (1≦j≦n) corresponding to i (i=1, . . . , n) outside of i₀ (1≦i₀≦n) is determined, the probability that j (i₀) which satisfies Equations (13) and (14) below is present is a maximum 1/q. Here, 1≦j(i₀)≦n.

g^{Σx}^{ⱼ₍ᵢ₎}^{α}^{ⁱ} mod q=Πyⱼ₍ᵢ₎ mod q (13)

j(i₀)≠j(i)(i=1, . . . , i₀−1,i₀,i₀+1, . . . , n) (14)

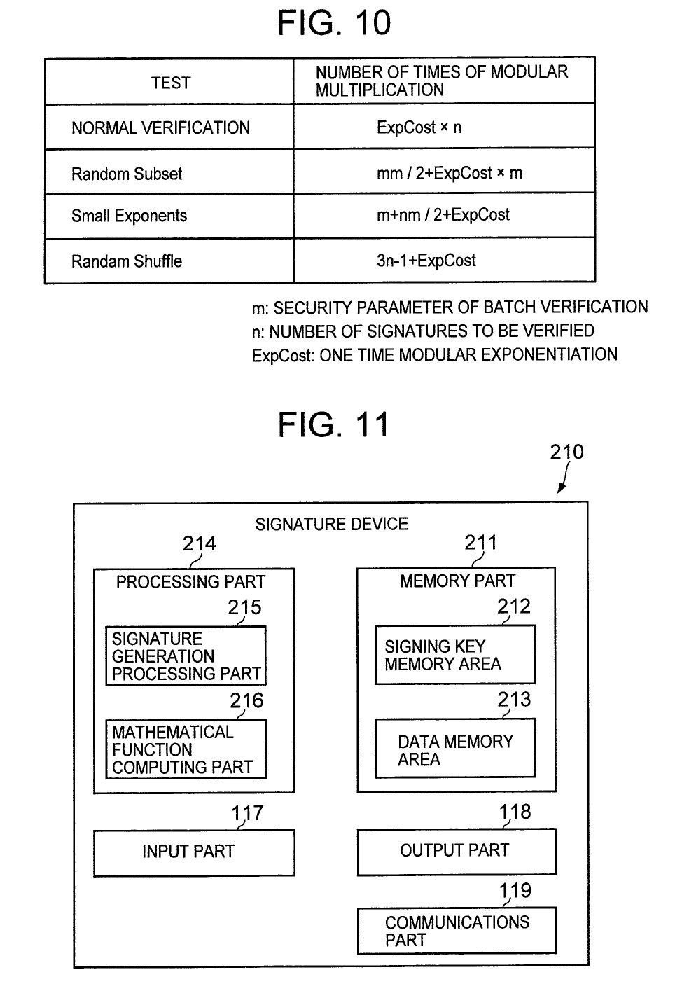

FIG. 10 is a comparative diagram exemplifying the computing cost (computing time) in the batch verification in Reference 1 and the batch verification (called the Random Shuffle Test in FIG. 10) in this embodiment.

As described above, the computing cost of the batch verification described in Reference 1 depends on both the number n of batch instances to be verified and a security parameter m, while in contrast the computing cost of the Random Shuffle Test in this invention only depends on the number n of batch instances to be verified.

Consequently, it can be seen that the batch verification described in this embodiment is more efficient compared to the batch verification in Reference 1.

The reason that the batch verification described in this embodiment provides high security is given below.

As mentioned above, it is known from the capabilities of recent computers that m should preferably be set at approximately 80. On the other hand, from the capability of recent computers and from attack methods with respect to mathematical functions as known up to the present, it is necessary to use a prime number of approximately 160 bits or greater for q.

Here, in contrast to the security level in the batch verification in Reference 1 being approximately 80, the security level in the batch verification in this embodiment is approximately 160. According to the above, it is well known that the higher the security level, the greater the security. Consequently, it can be seen that the batch verification of this embodiment also has high security.

As described above, according to the batch verification of this embodiment, by carrying out permutation and using a type of verification that can be computed efficiently, it is possible to obtain signature batch verification having both high security and high efficiency.

Furthermore, in the embodiment described above, instead of verifying Equation (15) below, Equation (16) is verified but there is no limitation to this mode.

g^{x}^{ᵢ}=yᵢ (15)

g^{x}^{ᵢ}^{α}^{ⁱ}=yᵢ^{α}^{ⁱ} (16)

For instance, instead of verifying Equation (17) below, Equation (18) may be verified.

xᵢg=yᵢ (17)

αⁱxᵢg=αⁱyᵢ (18)

However, the finite group G is an additive group.

Here, α in Equations (17) and (18) is an arbitrary natural number as described above but it is not limited to this condition and may be a number that is different due to the order i and may be, for example, an arbitrary function f(i) with i as the variable.

Next, an explanation is given regarding the signature batch verification system for the second embodiment. Embodiment 2 is an example in which this invention is applied to a DSA signature. Here, the dual signature batch system in this embodiment also has a signature device 210 and a verification device 230 in a manner similar to the first embodiment.

FIG. 11 is an outline of the signature device 210 used in this embodiment.

As shown in the diagram, the signature device 210 is composed of a memory part 211, a processing part 214, an input part 117, an output part 118 and a communications part 119, and because the input part 117, output part 118 and the communication part 119 are the same as those in the first embodiment, their explanation is omitted.

A signing key memory area 212 and a data memory area 213 are set up in the memory part 211.

The signing key, which is the key information when executing the signature, is stored in the signing key memory area 212. Here, the signing key x in the DSA signature is an integer such that x:x∈Z_{q-1}.

The message, which is the data to be electronically signed, is stored in the data memory area 213.

The processing part 214 is composed of the signature generation processing par 215 and the mathematical function computing part 216.

The signature generation processing par 215 controls the processing for generating the signature data with respect to the message, which is the data to be electronically signed.

For example, in this embodiment the signature generation processing par 215 generates the input data by inputting the message, which is the data to be electronically signed, into a predetermined hash function.

The signature generation processing par 215 receives the signing key stored in the signing key memory area 212 and inputs it along with the input data into the mathematical function computing part 216.

The signature generation processing par 215 receives the signature generated from the mathematical function computing part 216 and transmits it with the signature and the message as signature data to the verification device 230 through the communication part 139.

The mathematical function computing part 216 uses the signing key input from the signature generation processing par 215 with respect to the input data input from the signature generation processing par 215, encodes it by means of a predetermined algorithm and generates the signature.

In the DSA signature, the signature Si is computed by Equations (19) and (20) below with respect to the message Mᵢ (i=1, . . . , n) that uses the above described signing key x.

Sᵢ=(λᵢ,σᵢ) (19)

λᵢ=g^{k}^{ᵢ} mod q (20)

Here, Kᵢ is a random number generated when generating the signature and satisfies Equation (21) below.

kᵢ ∈ Z_{q}* (20)

Also, σᵢ satisfies Equation (22) below.

σᵢ={H(Mᵢ)+xλᵢ}kᵢ⁻¹ mod 1 (22)

Here, H is a cryptographic hash function.

Furthermore, (p, q, g), which are system parameters in the DSA signature, are as given below.

The prime number p:2^{L-1}<p<2^{L}, 512≦L≦1024, Lmod 64≡0.

The prime number q:q | (p−1), 2¹⁵⁹<q<2¹⁶⁰.

g:g=h^{(p-1)/q} modp with respect to a certain h ∈ Zₚ*.

These system parameters are publicly available on the network.

Here, Z_{q}* is the entire set of positive integers that is smaller than q in which the greatest common denominator of x and q is 1.

The mathematical function computing part 216 in this manner outputs the generated signature to the signature generation processing par 215.

The above described signature device 210 can also be realized with, for example, a general computer as shown in FIG. 5.

For example, the memory part 211 is realizable by having the CPU 161 use a memory 162 or an external memory device 163; the processing part 214 is realizable by having a predetermined program stored in the external memory device 163 loaded in the memory 162 and executed by the CPU 161; the input part 117 is realizable by having the CPU 161 use an input device 166: the output part 118 is realizable by having the CPU 161 use an output device 167; and the communication part 119 is realizable by having the CPU 161 use a communications device 168.

The predetermined program may be downloaded to the external memory device 163 from the memory medium 164 through the reading device 165 or from a network through the communications device 168 and then loaded into the memory 162 and executed by the CPU 161. Furthermore, it may also be directly loaded into the memory 162 from the memory medium 164 through the reading device 165 or from the network through the communication device 168 and executed by the CPU 161.

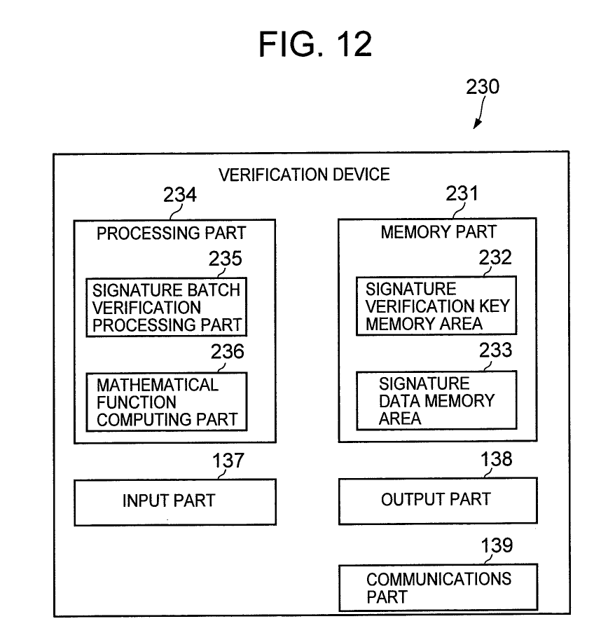

FIG. 12 is an outline of the verification device 230 used in this embodiment.

The verification device 230 is composed of the memory part 231, the processing part 234, the input part 137, the output part 138 and the communications part 139 and since the input part 137, the output part 138 and the communications part 139 are the same as in Embodiment 1, their explanation is omitted.

The signature verification key memory area 232 and the signature data memory area 233 are set up in the memory part 231.

The signature verification key which decodes the signature contained in the signature data transmitted from the signature device 210 and is the key information for verification is stored in the signature verification key memory area 232. Here, the signature verification key in the DSA signature is (y, g, p, q). And y=g^{x}.

The signature data transmitted from the signature device 210 is stored in the signature data memory area 233.

The processing part 234 is composed of the signature batch verification processing part 235 and the mathematical function computing part 236.

The signature batch verification processing part 235 controls the processing in which the signature data transmitted from the signature device 210 is batched and verified.

For example, in this embodiment, the signature batch verification processing part 235 receives the signature verification key stored in the signature verification key memory area 232 and the signature data stored in the signature data memory area 233 and inputs them into the mathematical function computing part 236.

The signature batch verification processing part 235 receives the results of batch verification from the mathematical function computing part 236 and either stores them in the memory part 231 or outputs the verification results through the output part 138 or the communications part 139.

The mathematical function computing part 236 carries out batch verification of the signatures by means of a predetermined algorithm using the signature verification key input from the signature batch verification part 235 with respect to the signatures contained in the signature data input from the signature batch verification part 235 and carries out batch processing of the signatures by means of a predetermined algorithm, and confirms the validity of the signatures.

Here, the mathematical function computing part 236 is not shown in the diagram but is composed of a batch instance generating part, a permutation part and a modular exponentiation computing part in a manner similar to the first embodiment.

With regard to the signatures generated by the DSA signature method, because it is necessary to transform the batch verification method so that it can be applied, the batch instance generating part in the mathematical function computing part 236 transforms the signatures received from the signature device 210 into a batch instance.

Specifically, the batch instance generating part of the mathematical function computing part 236 calculates the signature Si computed in Equation (19) above using λᵢ, kᵢ, σᵢ which satisfy Equations (20), (21) and (22) above and computes the batch instance by means of Equations (23), (24) and (25) below.

Sᵢ=(λᵢ, aᵢ, bᵢ) (23)

aₒ=σᵢ⁻¹H(Mᵢ)mod q (24)

bᵢ=σᵢ⁻¹λᵢ mod q (25)

The permutation part in the mathematical function computing part 236 carries out permutation of the batch instance converted by the batch instance generating part by an arbitrary method. Here, the permutation is carried out by a method similar to that in Embodiment 1.

For example, the order of the batch instance (λᵢ, aᵢ, bᵢ) i (i=1, . . . , n) is changed to (λ_{τ(i)}, a_{τ(i)}, b_{τ(i)}) (i=1, . . . , n). Here, τ is the symbol to identify the permutation method.

The modular exponentiation computing part in the mathematical function computing part 236 carries out verification based on if Equation (26) below is satisfied.

Πλ_{τ(i)}^{a ≡g}^{Σa}^{_{τ(i)}}^{α}^{ⁱ}×y^{Σb}^{_{τ(i)}}^{α}^{ⁱ} mod q (26)

That is, when Equation (26) is satisfied, the signature Sᵢ is received as “valid” and when it is not, the signature Sᵢ is rejected as “invalid”. Furthermore, α in Equation (26) is an arbitrary natural number. Here, αⁱ in Equation (26) is not limited to this condition and may be a number that is different than the order i and may, for example, be an arbitrary function f (i) in which i is the variable.

The above described verification device 230 may also be realized by a general computer 160 as shown in FIG. 5.

For example, the memory part 231 is realizable by having the CPU 161 use a memory 162 or an external memory device 163; the processing part 234 is realizable by having a predetermined program stored in the external memory device 163 loaded in the memory 162 and executed by the CPU 161; the input part 137 is realizable by having the CPU 161 use an input device 166: the output part 138 is realizable by having the CPU 161 use an output device 167; and the communication part 139 is realizable by having the CPU 161 use a communications device 168.

This predetermined program may be downloaded to the external memory device 163 from the memory medium 164 through the reading device 165 or from the network through the communications device 168, loaded into the memory 162 and executed by the CPU 161. Additionally, it may also be directly downloaded to the memory 162 from the memory medium 164 through the reading device 165 or from the network through the communications device 168 and executed by the CPU 161.

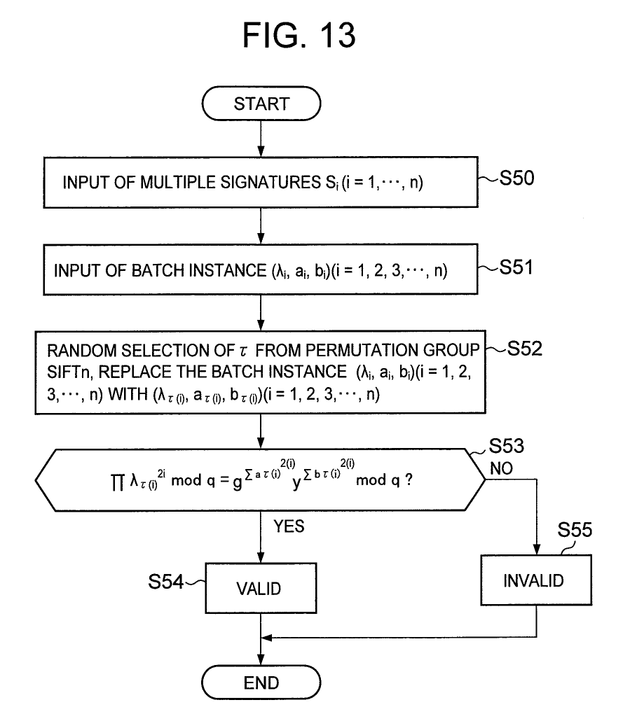

FIG. 13 is a flow chart exemplifying the batch verification processing in the mathematical function computing part 236 in this embodiment.

Batch verification processing in the mathematical function computing part 236 is started by the reception of the input of an arbitrary amount of signature data from the signature batch verification processing part 235 (S50).

When the input of the arbitrary amount of signature data is received from the signature batch verification processing part 235, the batch instance generating part in the mathematical function computing part 236 generates the batch instance (λᵢ, aᵢ, bᵢ) (i=1, . . . , n) from the multiple signatures Si (i=1, . . . , n) contained in the input signature data (S51).

The permutation part in the mathematical function computing part 236 randomly selects the permutation τ from the permutation group SIFTₙ, that is, it replaces order of the batch instance (λᵢ, aᵢ, bᵢ) ((i=1, . . . , n) to (λ_{τ(i)}, a_{τIi)}, b_{τ(i)}, . . . , n (S52).

Next, the modular exponentiation computing part in the mathematical function computing part 236 computes Equation (26) above using the replaced (λ_{τ(i)}, a_{τ(i)}, b_{τ(i)}) (S55).

The modular exponentiation computing part checks to see whether Equation (26) is satisfied and when it is (Yes in step S53), the signature is deemed to be valid (S54) and when it is not (No in step S53), the signature is deemed to be invalid (S55).

Furthermore, in this embodiment, verification processing is carried out with Equation (26) but if verification processing can be carried out, any verification equation may be used and the type of verification equation does not matter.

For this embodiment, an explanation has been given when batch-verifying multiple signatures (or batch instances) signed by certain singers, but multiple signatures (or batch instances) signed by multiple signers may also be batch-verified.

For example, the following methods are given for batch verification with respect to batch instance (λⱼ⁽ⁱ⁾, aⱼ⁽ⁱ⁾, bⱼ⁽ⁱ⁾) {1≦j≦n (i)} variously generated by at least one user Aᵢ(1≦i≦r) having a combination of the signing key skᵢ and the signature verification key pkᵢ {Skᵢ=xᵢ, pkᵢ=(yᵢ, g, p, q) } (here, yᵢ=g^{xi}). The first method replaces the batch instance for each user and verifies whether or not the equation in which both sides of Equation (23) above are variously multiplied for each user is satisfied.

The second method verifies whether or not Equation (26) is satisfied after the batch instances for all users Aᵢ(1≦i≦r) are replaced. However, with this method, it is necessary to change y on the right side of Equation (26) according to which user has generated a batch instance bᵢ.

The reason that the batch verification described in this embodiment can be more efficient when compared to the batch verification in Reference 1 is the same as for the first embodiment.

Additionally, the reason why the batch verification described in this embodiment has high security is also the same as for the first embodiment.

From the above, according to the batch verification of this embodiment, DSA signature batch verification is possible having both high security and high efficiency by using permutation and a verification equation that can be computed efficiently.

Furthermore, in the above described batch verification methods, a DSA signature method was used but it is also possible to use a DSA* signature in place of the DSA signature.

For a DSA* signature, because the batch instance is a signature computed using Equations (23), (24) and (25) above (because it is computed in the signature device), it is not necessary to generate a batch instance in the verification device 230.

Also, the DSA* signature is described in Reference 1 and its security is the same value as with the DSA signature.

Next, an explanation is given regarding the signature batch verification system in Embodiment 3. Embodiment 3 is an example in which this invention is applied to the ECDSA signature scheme. Here, the dual signature batch verification system in this embodiment is also composed of a signature device 310 and a verification device 330 in a manner similar to the first embodiment.

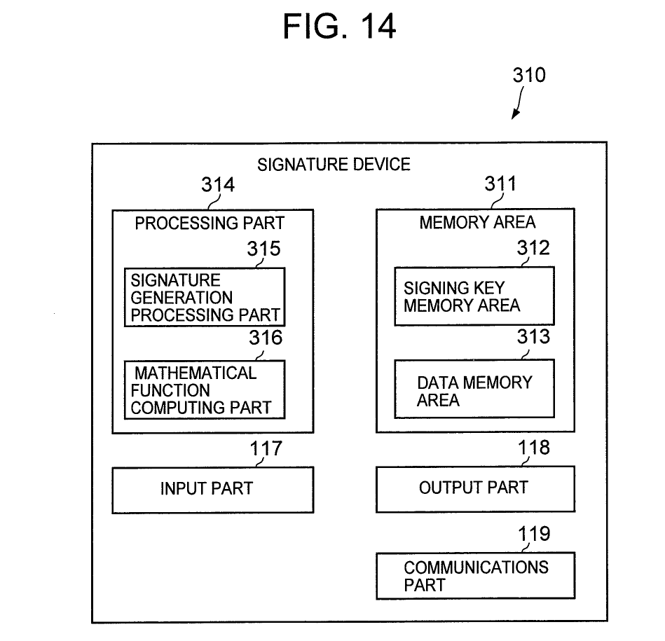

FIG. 14 is an outline of the signature device 310 used in this embodiment.

As shown in the diagram, the signature device 310 is composed of a memory part 311, a processing part 314, an input part 117, an output part 118 and a communications part 119 and because the input part 117, the output part 118 and the communications part 119 are the same as in Embodiment 1, their explanation is omitted.

The signing key memory area 312 and the data memory area 313 are set up in the memory part 311.

The signing key, which is the key information when executing the signature, is stored in the signing key memory area 312. Here, the signing key d in the ECDSA signature scheme is an integer d:d∈Zₙ₋₁. The message, which is the targeted data to be electronically signed, is stored in the data memory area 313.

The processing part 314 is composed of the signature generation processing par 315 and the mathematical function computing part 316.

The signature generation processing par 315 controls the processing for generating the signature data with respect to the message, which is the targeted data to be electronically signed.

For example, in this embodiment, the signature generation processing par 315 generates the input data by inputting the message, which is the targeted data for executing the signature, into a predetermined hash function.

The signature generation processing par 315 receives the signing key stored in the signing key memory area 312 and inputs it along with the input data into the mathematical function computing part 316.

The signature generation processing par 315 receives the signature generated by the mathematical function computing part 316 and transmits it with the signature and the message as the signature data to the verification device 330 through the communications part 139.

The mathematical function computing part 316 uses the signing key input from the signature generation processing par 315 with respect to the input data input from the signature generation processing par 315, carries out encoding by a predetermined algorithm and generates the signature.

In the ECDSA signature scheme, the signature Sᵢ is calculated with Equations (27), (28) and (29) below with respect to the message Mᵢ (i=1, . . . , n), which uses the above described signing key d.

Sᵢ=(rᵢ, σᵢ) (27)

Rᵢ=kᵢP (28)

rᵢ=x(Rᵢ)mod n (29)

σᵢ={H(Mi)+dx(Rᵢ)}kᵢ⁻¹ mod n (30)

Here, H is a cryptographic hash function. Also, x(Rᵢ) is the x coordinate of a point Rᵢ on an elliptic curve E(F_{q}).

Additionally, Kᵢ is a random number generated when generating the signature, and satisfies Equation (31) below.

kᵢ ∈ Zₙ₋₁ (31)

Furthermore, the system parameters in the ECDSA signature scheme are given below.

E/F_{q}: the elliptic curve defined over a finite field F_{q}.

q: a power of a prime number p in which the bit size is 160 or greater.

#E (F_{q})=n×h (here, h is a small integer, n is a large prime number).

P: a point on E (F_{q}) such that the order is n.

These system parameters are publicly available on the network.

The mathematical function computing part 316 outputs the signature generated in this manner to the signature generation processing par 315.

The signature device 310 described above can also be realized with, for example, a general computer 160 as shown in FIG. 5.

For example, the memory part 311 is realizable by having the CPU 161 use a memory 162 or an external memory device 163; the processing part 314 is realizable by having a predetermined program stored in the external memory device 163 loaded into the memory 162 and executed by the CPU 161; the input part 117 is realizable by having the CPU 161 use the input device 166; the output part 118 is realizable by having the CPU 161 use the output device 167; and the communications part 119 is realizable by having the CPU 161 use the communications device 168.

This predetermined program may be downloaded to the external memory device 163 from the memory medium 164 through the reading device 165 or from the network through the communications device 168, loaded into the memory 162 and executed by the CPU 161. Additionally, it may be directly loaded in the memory 162 from the memory medium 164 through the reading device 165 or from the network through the communications device 168 and executed by the CPU 161.

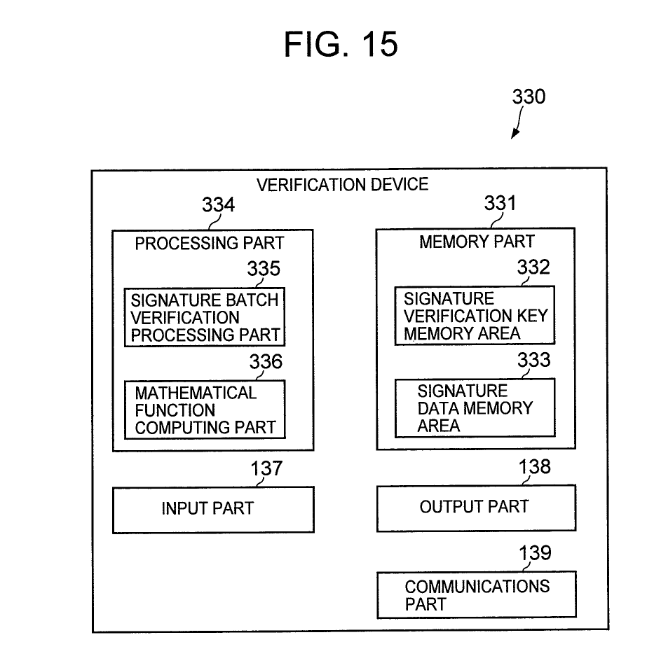

FIG. 15 is an outline of the verification device 330 used in this embodiment.

The verification device 330 is composed of the memory part 331, the processing part 334, the input part 137, the output part 138 and the communications part 139 and because the input part 137, the output part 138 and the communications part 139 are the same as in the first embodiment, their explanation is omitted.

The signature verification key memory area 332 and the signature data memory area 333 are set up in the memory part 331.

The signature verification key, which is the key information to decode and verify the signature contained in the signature data transmitted from the signature device 310, is stored in the signature verification key memory area 332. Here, in the signature verification key Q in the ECDSA signature scheme, Q=dP.

The signature data transmitted from the signature device 310 is stored in the signature data memory area 333.

The processing part 334 is composed of the signature batch verification processing part 335 and the mathematical function computing part 336.

The signature batch verification processing part 335 controls the processing for batch verification of the signature data transmitted from the signature device 310.

For example, in this embodiment, the signature batch verification processing part 335 receives the signature verification key stored in the signature verification key memory area 332 and the signature data stored in the signature data memory area 333 from memory part 331 and inputs them into the mathematical function computing part 336.

The signature batch verification processing part 335 receives the results of the batch verification from the mathematical function computing part 336 and either stores them in the memory part 331 or outputs the verification results through the output part 138 or the communications part 139.

The mathematical function computing part 336, with respect to the signatures contained in the signature data input from the signature batch verification part 335, uses the signature verification key input from the signature batch verification part 335, carries out the batch verification of the signatures by means of a predetermined algorithm, and verifies the validity of the signatures.

Here, the mathematical function computing part 336 is not shown in the diagram but is different from the first embodiment and is composed of a batch instance generating part, a permutation part, and a scalar multiplication computing part.

Furthermore, the scalar multiplication computing part carries out verification by scalar multiplication computing of the batch instances replaced by the permutation part.

With regard to the signatures generated by the ECDSA signature scheme method, because it is necessary to transform the batch verification method so that it may be applied, the batch instance generating part in the mathematical function computing part 336 transforms the signatures received from the signature device 310 into the batch instances.

Specifically, the batch instance generating part in the mathematical function computing part 336 calculates the batch instance shown in Equation (32) below in which the signature Sᵢ calculated in Equation (27) above is shown using Equations (28), (29) and (30) above.

Sᵢ=(σᵢRᵢ) (32)

The permutation part in the mathematical function computing part 336 carries out permutation of the batch instance transformed by the batch instance generating part by an arbitrary method. Here, it is the same method that carries out the replacement in the first embodiment.

For example, the order of the batch instance (σᵢ, Rᵢ) (i=1, . . . , n) is changed to (σ_{τ(i)}, R_{τ(i)}) (i=1, . . . , n). Here, τ is the symbol representing the replacement method.

The scalar multiplication computing part in the mathematical function computing part 336 carries out verification of whether Equation (33) below is satisfied or not.

ΣαⁱR_{τ(i)}=(Σa_{τ(i)}αⁱ mod n)P+(Σb_{τ(i)}αⁱ mod n)Q (33)

That is, when Equation (33) is satisfied, the signature Sᵢ is received as “valid” and when it is not, the signature Sᵢ is rejected as “invalid”. Furthermore, α in Equation (33) is an arbitrary natural number. Here, αⁱ in Equation (33) is not limited to this condition and may be a number that depends on the order i, for example, an arbitrary function f(i) with i as the variable.

The above described verification device 330 may also be achieved with a general computer 160 as shown in FIG. 5.

For example, the memory part 331 is realizable by having the CPU 161 use a memory 162 or an external memory device 163; the processing part 334 is realizable by having a predetermined program stored in the external memory device 163 loaded into the memory 162 and executed by the CPU 161; the input part 137 is realizable by having the CPU 161 use the input device 166; the output part 138 is realizable by having the CPU 161 use the output device 167; and the communications part 139 is realizable by having the CPU 161 use the communications device 168.

This predetermined program may be downloaded to the external memory device 163 from the memory medium 164 through the reading device 165 or from the network through the communications device 168, loaded into the memory 162 and executed by the CPU 161. Additionally, it may be directly loaded into the memory 162 from the memory medium 164 through the reading device 165 or from the network through the communications device 168 and executed by the CPU 161.

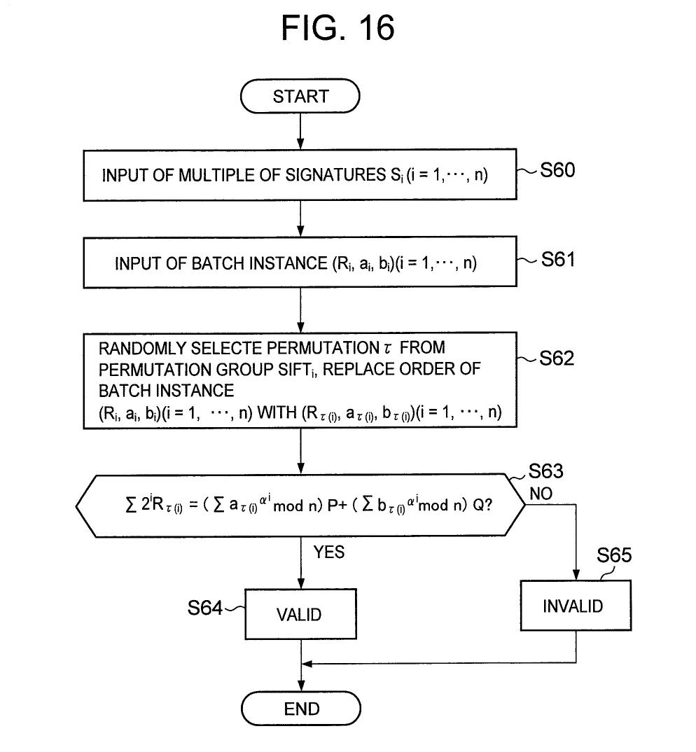

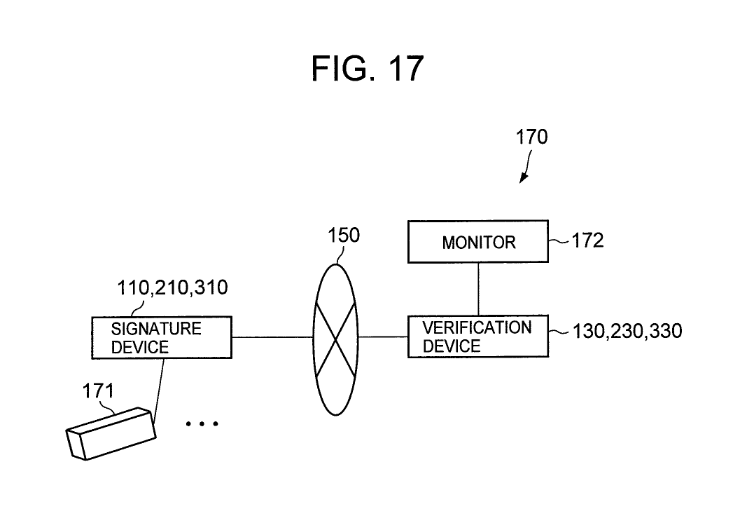

FIG. 16 is a flow chart exemplifying the batch verification processing with the mathematical function computing part 336 for this embodiment.

The batch verification processing in the mathematical function part 336 is begun with the reception of the input of an arbitrary amount of signature data by the signature batch verification processing part 335 (S60).

When receiving the input of the arbitrary amount of signature data from the signature batch verification processing part 335, the batch instance generating part in the mathematical function computing part 336 generates the batch instance (σᵢ, Rᵢ) (i=1, . . . , n) from the multiple signatures Si (i=1, . . . , n) contained in the input signature data (S61).

The permutation part in the mathematical function computing part 336 randomly selects the permutation τ from the permutation group SIFTₙ, that is, with the arbitrary permutation method the order of the batch instance (σᵢ, Rᵢ) (i=1, . . . , n) is changed to (σ_{τ(i)}, R_{τ(i)}) (i=1, . . . , n) (S62).

Next, the scalar multiplication computing part in the mathematical function computing part 336 calculates Equation (33) above using the replaced batch instance (σ_{τ(i)},R_{τ(i)}) (i=1, . . . , n) (S63).

The scalar multiplication computing part checks whether or not Equation (33) is satisfied and when it is (Yes in step S63), the signature is determined to be valid (S64) and when it is not (No in step S53), the signature is determined to be invalid (S65).

Furthermore, in this embodiment, verification processing is carried out with Equation (33) but if it is possible to carry out verification processing, any verification equation may be used and the verification equation may be of any type.

In this embodiment, an explanation has been given when batch verifying multiple signatures (or batch instances) signed by certain signers but it is also possible to batch verify multiple signatures (or batch instance) signed by a multiple signers.

For example, the following methods are cited as batch processing with regard to the batch instance (σᵢ⁽ⁱ⁾, aⱼ⁽ⁱ⁾, bⱼ⁽ⁱ⁾) {1≦j≦n (i)} in which at least more than one user Aᵢ(1≦i≦r) has generated a signing key skᵢ and a signature verification key pkᵢ pair (skᵢ=dᵢ, pkᵢ=Qᵢ) (here, Qᵢ=dᵢP).

The first method replaces the batch instance for each user and verifies whether or not the equation in which both sides of Equation (33) above are variously multiplied for each user is satisfied.

The second method verifies whether or not Equation (33) is satisfied after the batch instances for all users Aᵢ(1≦i≦r) are replaced. However, with this method, it is necessary to change Q on the right side of Equation (33) due to whether or not it is a batch instance in which Rᵢ is generated depending on who the user is.

The reason the above described batch verification in this embodiment can be more efficient when compared to the batch verification in Reference 1 is the same as for the first embodiment.

Furthermore, the reason the batch verification in this embodiment has high security is also the same as for the first embodiment.

From the above, according to this embodiment, by using permutation and using an efficiently computable verification equation, it is possible to obtain ECDSA signature batch verification having both high security and high efficiency.

Moreover, the ECDSA signature scheme method was used in the above described batch verification method but ECDSA* signatures may also be used in place of the ECDSA signature schemes.

For the ECDSA* batch signatures, it is not necessary to generate a batch instance in the verification device 330 because the batch instance computed by Equation (32) is a signature (computed by the signature device).

Also, the ECDSA* signature is described in Reference 2 and its security is equivalent to that of the ECDSA signature scheme.

Furthermore, in each of the above described embodiments, the signature generation processing par and the signature batch verification processing part have been explained as being achievable with software, but they may also be achieved using special hardware. Additionally, the mathematical function computing part may also be achieved with special hardware.

The above described signature batch verification systems can be used as systems in which a large quantity of signature data from the signature devices 110, 210 and 310 is transmitted to the verification devices 130, 230 and 330.

For instance, they can be used in the real time monitoring system 170 which uses a monitoring camera as shown in FIG. 17 (outline of the real time monitoring system 170).

As shown in the diagram, the real time monitoring system 170 is composed of a monitoring camera 171; a signature device 110. 210 or 310; a verification device 130, 230 or 330; and a monitor 172, and the signature device 110, 210 or 310 and the verification device 130, 230 or 330 is connected to the network 150.

For example, the monitoring camera 171 is set up in the targeted observation area, the images taken are sent to the verification device 130, 230 or 330 set up in the observation center in, for example, the security company through the network 150 as the signature data in the signature device 110, 210 or 310 and stored in the verification device 130, 230 or 330.

In the verification device 130, 230 or 330, when the necessity arises to verify the images taken which are contained in the stored signature data, by batching and checking the required part in the stored signature data, it is possible to check that it was taken by the specific monitoring camera 171 and that the data has not been altered.

When conducting this verification, by carrying out batch verification according to this invention, it is possible for the verification to be executed efficiently with high security.

The specification and drawings are, accordingly, to be regarded in an illustrative rather than a restrictive sense. It will, however, be evident that various modifications and changes may be made thereto without departing from the spirit and scope of the invention as set forth in the claims.

What is claimed is:

1. A batch verification device that batch-verifies batch instances of multiple signature data, an order being specified in the multiple signature data, and the batch instance having a first value and a second value, the batch verification device comprising: a processing part which carries out verification based on whether or not a value calculated by carrying out a modular exponentiation of a generator of a finite multiplicative cyclic group, with a multiplied value, obtained by multiplying the first value by a number which differs depending on the order, as an exponent, and a value calculated by carrying out a modular exponentiation of the second value, with a number which differs depending on the order as an exponent, are in agreement.

2. The batch verification device according to claim 1 wherein the processing part carries out verification based on whether or not
a value calculated by multiplying a value calculated by carrying out an exponentiation of the generator of a finite multiplicative cyclic group in all of the batch instances, with a multiplied value, obtained by multiplying the first value by a number which differs depending on the order, as an exponent, and
a value calculated by multiplying a value calculated by carrying out a modular exponentiation of the second value in all of the batch instances, with a number which differs depending on the order as an exponent, are in agreement.

3. The batch verification device according to claim 1 wherein the processing part carries out verification after the order of the batch instances is changed at least once.

4. The batch verification device according to claim 3, wherein the processing part, having a multiple change methods that change the order of the batch instances, changes the order of the batch instances using a positional change method selected from the multiple change methods.

5. A batch verification device that batch-verifies batch instances of multiple signature data, an order being specified in the multiple signature data, and the batch instance having a first value and a second value, the batch verification device comprising:
a processing part which carries out verification based on whether or not a value obtained by calculating a scalar multiplication of a generator of a finite additive cyclic group, with a multiplied value, calculated by multiplying the first value by a number which differs depending on the order, as a scalar value, and a value obtained by calculating a scalar multiplication of the second value, with a number which differs depending on the order, as a scalar value, are in agreement.

6. The batch verification device according to claim 5 wherein the processing part carries out verification based on whether or not a value obtained by calculating a scalar multiplication of a generator of a finite additive cyclic group in all the batch instances and adding all the calculated values, with a multiplied value, calculated by multiplying the first value by a number which differs depending on the order, as a scalar value, and a value obtained by calculating a scalar multiplication of the second value in all the batch instances and adding all the calculated values, with a number which differs depending on the order, as a scalar value, are in agreement.

7. The batch verification device according to claim 5 wherein the processing part carries out verification after the order of the batch instances is changed at least once.

8. The batch verification device according to claim 7 wherein the processing part has a multiple change methods that change the order of the batch instances and change the order of the batch instances using a positional change method selected from the multiple change methods.

9. A program that causes a computer to carry out processing in which batch instances of multiple signature data are batch-verified, an order being specified in the multiple signature data, and a batch instance having a first value and a second value, wherein
the program causes the computer to function as a processor which carries out verification based on whether or not a value calculated by carrying out an exponentiation of a generator of a finite multiplicative cyclic group, with a multiplied value, obtained by multiplying the first value by numbers which differ depending on the order, as an exponent, and a value calculated by carrying out a modular exponentiation of the second value, with a number which differs depending on the order, as an exponent, are in agreement.

10. The program according to claim 9, wherein the processor carries out verification based on whether or not a value calculated by multiplying a value calculated by carrying out a modular exponentiation of a generator of a finite multiplicative cyclic group in all of the batch instances, with a multiplied value, obtained by multiplying the first value by a number which differs depending on the order, as an exponent, and the value calculated by multiplying a value calculated by carrying out a modular exponentiation of the second value in all of the batch instances, with a number which differs according to the order as an exponent, are in agreement.

11. The program according to claim 9 wherein the processor carries out verification after the order of the batch instances is changed at least once.

12. The program according to claim 11 wherein the processor, having a multiple change methods that change the order of the batch instances, changes the order of the batch instances using a positional change method selected from the multiple change methods.

13. A program that causes a computer to carry out processing in which batch instances of multiple signature data are batch-verified, an order being specified in the multiple signature data, and a batch instance having a first value and a second value, wherein
the program causes the computer to function as a processor which carries out verification based on whether or not a value obtained by calculating a scalar multiplication of a generator of a finite additive cyclic group, with a multiplied value, calculated by multiplying the first value by a number which differs depending on the order, as a scalar value, and a value obtained by calculating a scalar multiplication of the second value, with a number which differs depending on the order as a scalar value, are in agreement.

14. The program according to claim 13 wherein the processor carries out verification based on whether or not a value obtained by calculating a scalar multiplication of a generator of a finite additive cyclic group in all the batch instances and adding all the calculated values, with a multiplied value, calculated by multiplying the first value by a number which differs depending on the order, as a scalar value; and a value obtained by calculating a scalar multiplication of the second value in all the batch instances and adding all the calculated values, with a number which differs depending on the order a scalar value, are in agreement.

15. The program according to claim 13 wherein the processor carries out verification after the order of the batch instances is changed at least once.

16. The program in the batch verification device according to claim 15, wherein the processor, having a multiple change methods for changing the order of the batch instances, changes the order of the batch instances using a positional change method selected from the multiple change methods.

17. A batch verification method in which a batch verification device comprises a processing part that batch-verifies batch instances of multiple signature data, an order being specified in the multiple signature data, and a batch instance having a first value and a second value, wherein the processing part performs a verifying process based on whether or not a value calculated by carrying out a modular exponentiation of a generator of a finite multiplicative cyclic group, with a multiplied value, obtained by multiplying the first value by a number which differs depending on the order, as an exponent, and a value calculated by carrying out a modular exponentiation of the second value, with a number which differs depending on the order as an exponent, are in agreement.

18. A batch verification method in which a batch verification device comprises a processing part that batch-verifies batch instances of multiple signature data, an order being specified in the multiple signature data, and a batch instance having a first value and a second value, wherein the processing part performs a process of determining whether or not a value obtained by calculating a scalar multiplication of a generator of a finite additive cyclic group, with a multiplied value, obtained by multiplying the first value by a number which differs depending on a value of i, as a scalar value, and a value obtained by calculating a scalar multiplication of the second value, with a number which differs depending on the value i, as a scalar value, are in agreement.
